(19) United States
(12) Patent Application Publication
(10) Pub. No.: US 2004/0205375 A1
(43) Pub. Date: Oct. 14, 2004

(54) Method and apparatus for testing network system, and computer-readable medium encoded with program for testing network system

(76) Inventor: Tatsuzo Osawa, Ota-ku (JP)

Correspondence Address: SWIDLER BERLIN SHEREFF FRIEDMAN, LLP, 3000 K STREET, NW, BOX IP, WASHINGTON, DC, 20007, US

(21) Appl. No.: 10/765,868

(22) Filed: Jan. 29, 2004

(30) Foreign Application Priority Data
Mar. 31, 2003 (JP) 2003-097431

(51) Int. Cl. H02H 3/05

(52) U.S. Cl. 714/4

(57) ABSTRACT

A network-system testing method includes a judgment step of a judgment step of judging whether the received communication data, the communication data being transferred between an external device connected to a network device via a network and a virtual machine in the network device, coincides with the condition by referring to a test access control list (ACL) whitch defines association between a condition cocerning an attribute of the communication data and an action serving as a process of permitting or rejecting communication of the communication data; and an execution step of executing, when it is judged that the communication data coincides with the condition, the process serving as the action in the test access control list.

### BACKGROUND OF THE INVENTION

1. Field of the Invention

The present invention relates to a method and apparatus and to a computer-readable medium encoded with a program for testing the operation of the entire network system upon changing the settings of a network device in the network system.

2. Description of the Related Art

To change the settings or upgrade a so-called network device, such as a firewall device or a router, in a known network system, basically the operation of the network device, that is, the operation of the network system, must be stopped in order to perform the task of changing the settings or upgrading. To prevent such a network system stoppage, some network devices include, in terms of hardware, a plurality of central processing units (CPUs) or, in terms of software, a plurality of virtual machines, thereby implementing a plurality of network device functions in the individual network devices. Therefore, the operating system is quickly switched while the system whose settings have been changed is maintained in advance, thereby minimizing the stoppage time of the network system.

Japanese Unexamined Patent Application Publication No. 2001-318797 describes a firewall device including a plurality of virtual machines.

According to the related art, although the stoppage time due to the task of changing the settings is minimized, an error in the change of settings or a failure of the new version of software controlling the network device may occur due to the configuration of the network system including the network device and an external device, which are tightly coupled to each other. As a result, a failure may occur in the changed network system. To prevent such problems, the foregoing settings change must be performed during off-peak periods, such as late at night, when failures have a less drastic effect. Alternatively, a test period must be provided prior to the actual operation. In other words, there must be a time during which the network system stops operating.

### SUMMARY OF THE INVENTION

Accordingly, it is an object of the present invention to provide a method for performing, upon changing the settings of a network device, a test in order to avoid errors and failures in the changed settings without stopping the network system.

A method for testing a network system according to the present invention includes a reception step of receiving communication data transferred between an external device connected to a network device via a network and a virtual machine in the network device; a judgment step of judging whether the received communication data coincides with the condition by referring to a test access control list (ACL) whitch defines association between a condition concerning an attribute of the communication data and an action serving as a process of permitting or rejecting communication of the communication data; and an execution step of executing, when it is judged that the communication data coincides with the condition, the process of the action in the test access control list.

According to the present invention, a test can be performed on a network system whose settings have been changed without stopping the network system.

### BRIEF DESCRIPTION OF THE DRAWINGS

FIG. 1 is a connection diagram according to a first embodiment of the present invention;

FIG. 2 is a block diagram of a network device according to the present invention;

FIG. 3 is a diagram of the structure of a test ACL of the first embodiment;

FIG. 4 is a diagram of a test client IP address list;

FIG. 5 includes diagrams of examples of communication data of the first embodiment;

FIG. 6 is a flowchart describing a process of an inward communication judgment program;

FIG. 7 is a flowchart describing a process of an outward communication judgment program;

FIG. 8 is a flowchart describing a process of comparing communication data with conditions of the test ACL;

FIG. 9 is a diagram of an example of the specific operation of the present invention;

FIG. 10 is a diagram of another example of the specific operation of the present invention;

FIGS. 11A to 11C are diagrams of another examples of the structure of test ACLs of the first embodiment;

FIG. 12 includes diagrams of another examples of communication data of the first embodiment;

FIG. 13 is a connection diagram according to a second embodiment of the present invention; and

FIGS. 14A to 14C are diagrams of examples of the structure of test ACLs of the second embodiment.

### DESCRIPTION OF THE PREFERRED EMBODIMENTS

With reference to the drawings, the preferred embodiments of the present invention will now be described.

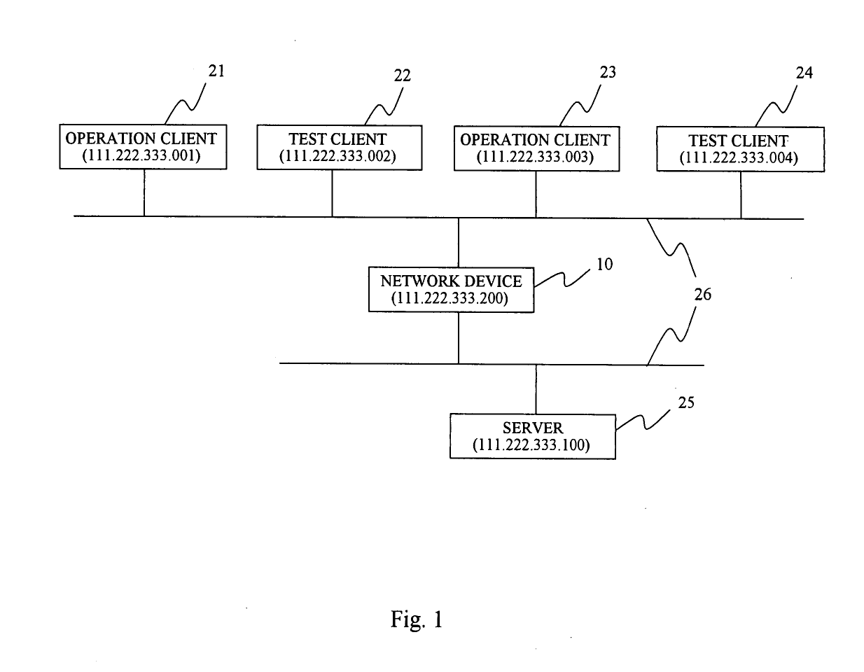

FIG. 1 shows the connection in a system according to a first embodiment of the present invention. In this system, a server 25 is connected to a network device 10 via a network 26, and the network device 10 is connected to operation clients 21 and 23 via a network 26. As a result, the server 25 is connected to the clients via a network device 10. This network device 10 is a device such as a firewall device or a router that appropriately controls communication data transferred over a network. Although the normal operation is performed by the operation clients 21 and 23, test clients 22 and 24 are also connected, serving as dedicated clients only for testing the changed settings of the network device 10. Each device is given an IP address (in parentheses) serving as identification information on the network 26.

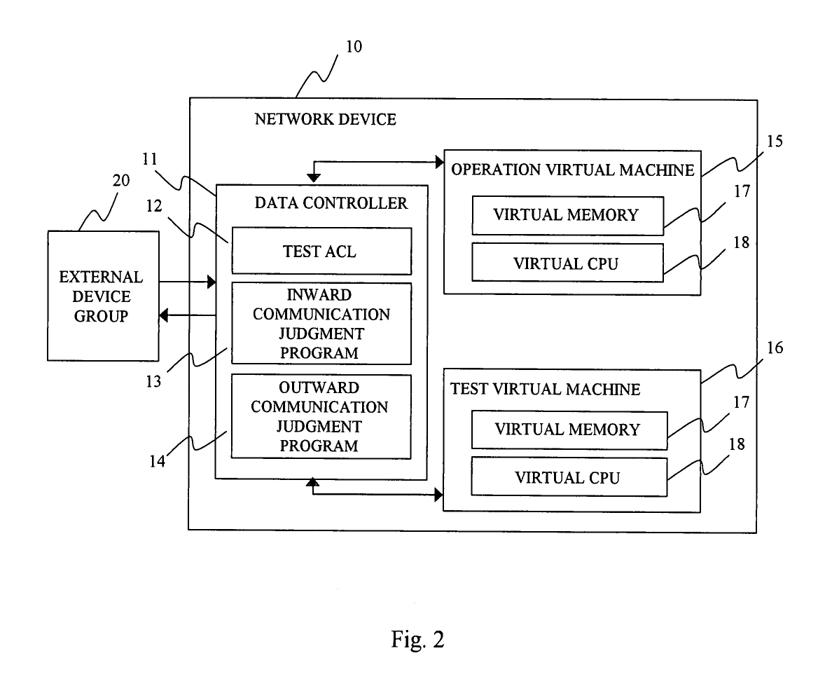

FIG. 2 shows the schematic internal structure of the network device 10. A data controller 11 has a function of controlling communication data transferred between an external device group 20 and an operation virtual machine 15 or a test virtual machine 16 included in the network device 10. This external device group 20 is a general term for the server 25, the test clients 22 and 24, the operation clients 21 and 23, and the like. The data controller 11 includes a test access control list (ACL) 12, an inward communication judgment program 13, and an outward communication judgment program 14. The inward communication judgment program 13 describes a process of referring to the test access control list (ACL) 12, judging whether communication data received from the external device group 20 coincides with an attribute condition(s), and, when the communication data coincides with the attribute condition(s), performing a corresponding action. The outward communication judgment program 14 describes a process of referring to the test ACL 12, judging whether communication data received from the virtual machine coincides with an attribute condition(s), and, when the communication data coincides with the attribute condition(s), performing a corresponding action. The operation virtual machine 15 performs the functions of network device 10. The test virtual machine 16 is equivalent in terms of the basic structure to the operation virtual machine 15 and performs the functions of the network device 10. The test virtual machine 16 differs from the operation virtual machine 15 in that the test virtual machine 16 has the changed settings. The virtual machines 15 and 16 each have a virtual CPU 17 and a virtual memory 18 and they operate as if they were independent devices. The virtual machines 15 and 16 may be, in terms of software, a plurality of machines operating in a network device operated by, in terms of hardware, a single CPU. Alternatively, a single network device may include a plurality of CPUs, which are independent from one another in terms of hardware.

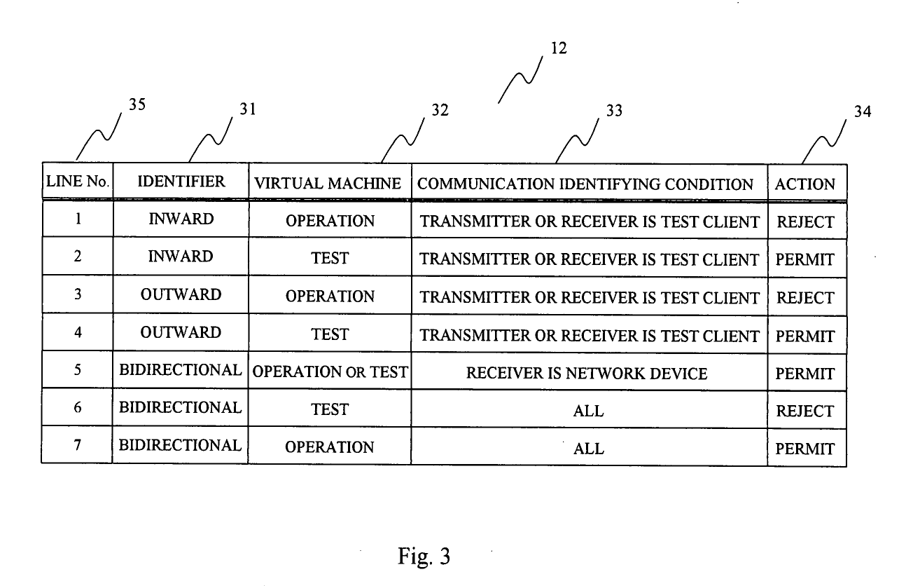

The test ACL 12 is a table defining the association betweeen one or plural conditions concerning an attribute(s) of communication data and an action of permitting or rejecting communication. The data controller 11 judges whether received communication data coincides with the condition(s) concerning the attribute(s) in the test ACL 12 and, when the communication data coincides with the condition(s), performs a process associated with the action. Referring to FIG. 3, the test ACL 12 of the first embodiment includes an identifier 31, a virtual machine 32 that performs processing, and a communication identifying condition 33, which is a condition concerning the attribute of communication data. When the communication data coincides with the condition, the processing, namely, rejecting or permitting, which is associated with an action 34, is performed. The term rejecting means literally rejecting the communication data at that time and not outputting the communication data outside the data controller 11. The term permitting means, when communication is inward, transmitting the communication data to a virtual machine specified by the attribute and, when communication is outward, outputting the communication data to the outside.

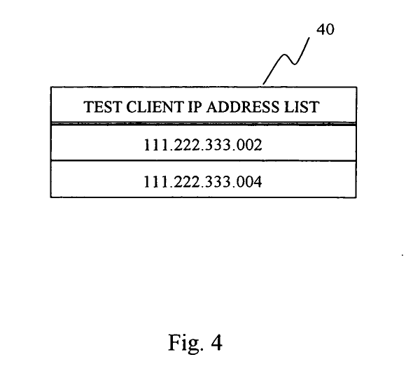

FIG. 4 shows a test client IP address list 40 of IP addresses of additional test clients connected to the network 26. These test clients are connected to test the changed settings. Since the communication identifying condition in the test ACL 12 of the first embodiment requires that the transmitter or the receiver of the communication data be a test client, information on the IP address of each test client, that is, the test client IP address list 40, is necessary. The test client IP address list 40 is included in the data controller 11, although not shown in FIG. 2.

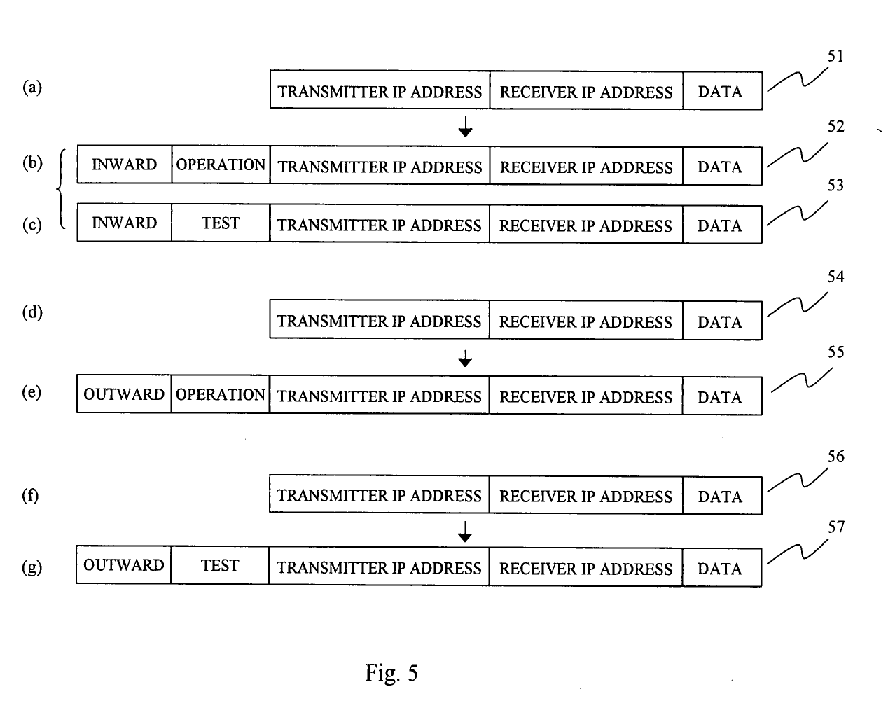

FIG. 5 shows examples in which the data controller 11 adds, where necessary, attributes to the communication data prior to performing judgment by referring to the test ACL 12. The details of these examples will be described later.

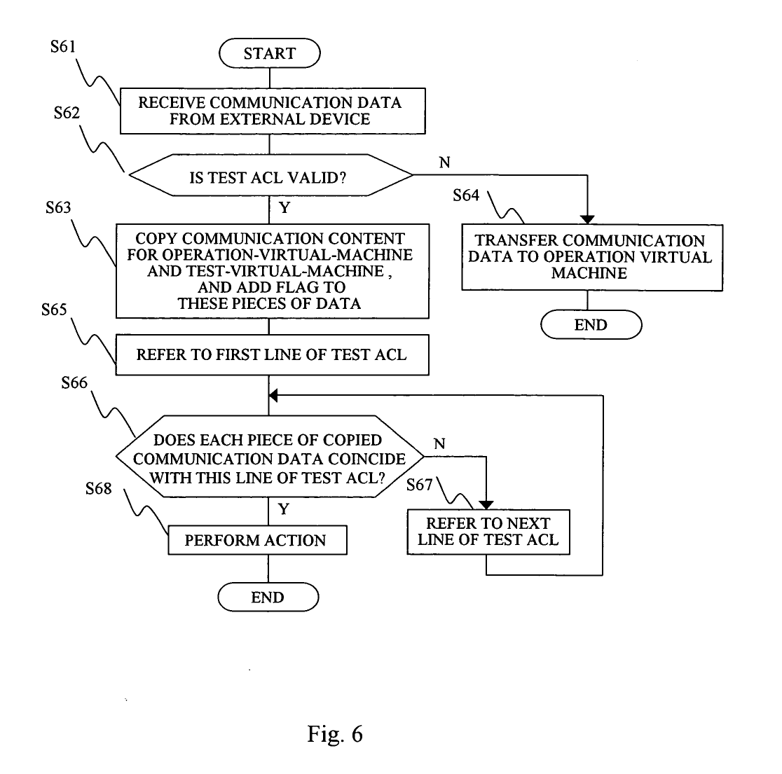

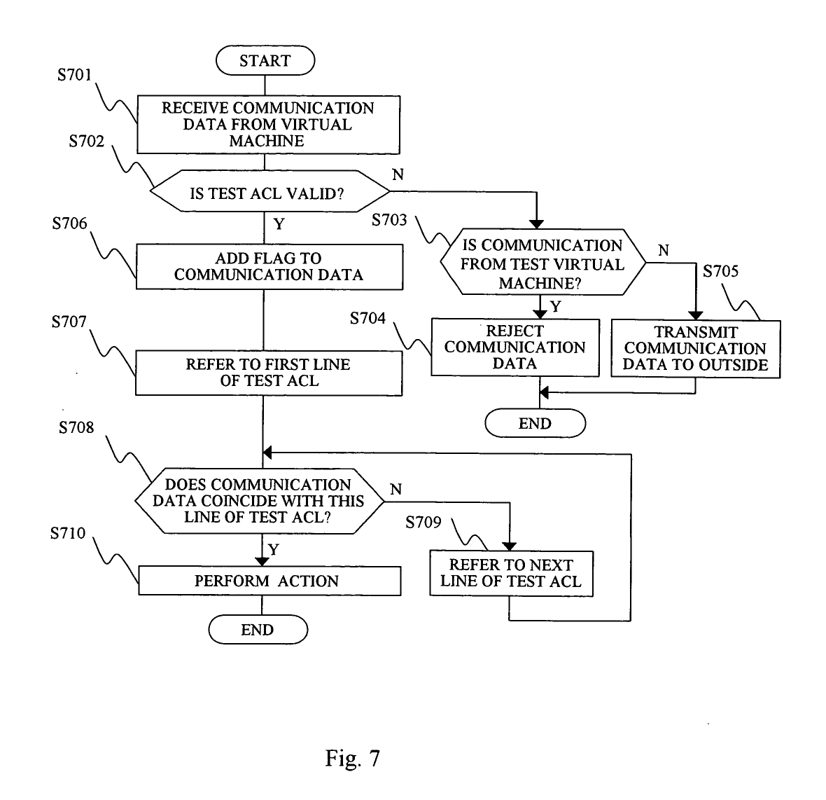

Referring to the flowcharts of FIGS. 6 to 8, an example of the operation of the present invention will now be described. In normal transmission and reception of communication data, when communication data is transmitted from one external device to another external device, the transmitting external device transmits the communication data, and the network device 10 receives the communication data. This first half of the processing is illustrated in FIG. 6. After the network device 10 performs appropriate processing, the network device 10 transmits the communication data, and the receiving external device receives the communication data. This second half of the processing is illustrated in FIG. 7.

FIG. 6 is a flowchart of a process of referring to, by the data controller 11, upon reception of communication data from the external device group 20 including the server and clients, the test ACL 12 and judging an action to be performed on the communication data.

In step S61, the data controller 11 receives communication data 51 from the external device group 20. Referring to portion (a) of FIG. 5, the received communication data 51 includes at least a transmitter IP address, a receiver IP address, and data. When the communication data 51 is transmitted from the test client 22 to the server 25, the IP address of the test client 22 is set as the transmitter IP address, and the IP address of the server 25 is set as the receiver IP address.

In step S62, it is judged whether the test ACL 12 is valid. Specifically, the test ACL 12 is valid when a test is to be conducted on the changed settings of the network device 10. In contrast, the test ACL 12 is invalid when no test is to be conducted on the settings; that is, the communication data 51 is in a normal operating state. Although not shown in the drawing, this judgment may be performed by, for example, referring to a flag area, which is provided in a memory, indicating whether the test ACL 12 is valid. When it is judged in step S62 that the test ACL 12 is invalid, the process proceeds to step S64.

In step S64, the received communication data 51 is transmitted to the operation virtual machine 15. Since no test is to be performed on the changed settings of the network device 10, the communication data 51 received from the external device group 20 is in a normal operating state. The communication data 51 is processed by the operation virtual machine 15 in the network device 10.

In step S63, the received communication data 51 is copied to, as shown in portions (b) and (c) of FIG. 5, operation-virtual-machine communication data 52 and test-virtual-machine communication data 53. Upon copying the data, an “inward” flag indicating that the data is communication data from the external device group 20 to a virtual machine in the network device 10, an “operation” flag indicating that the data is the communication data 52 for the operation virtual machine 15, and a “test” flag indicating that the data is the communication data 53 for the test virtual machine 16 are added. Assuming that these pieces of data will appropriately be permitted or rejected on the basis of the judgment, these pieces of data are created as temporary communication data for the corresponding virtual machines.

In step S65, the data controller 11 refers to conditions concerning attributes in the first line of the test ACL 12.

In step S66, it is judged whether each of the operation-virtual-machine communication data 52 and the test-virtual-machine communication data 53 coincides with the conditions concerning the attributes in the test ACL 12.

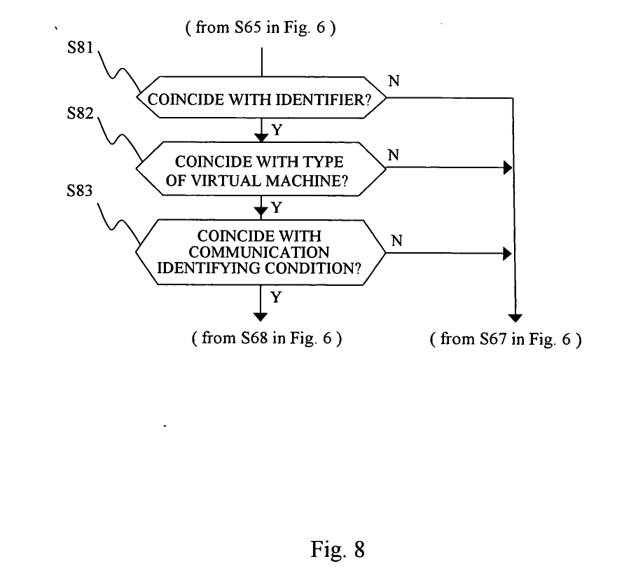

FIG. 8 shows the details of this judgment process. In step S81, the process refers to the identifier 31 and judges whether the identifier 31 coincides with the “inward” or “outward” flag of the communication data. The “inward” flag indicates that the data is communication data transmitted from the external device group 20 to the virtual machine in the network device 10. In contrast, the “outward” flag indicates that the data is communication data transmitted from the virtual machine to the external device group 20. In step S82, the process refers to a flag indicating the type of virtual machine, the flag being included in the communication data, and a field of the virtual machine 32 and judges whether the flag coincides with the field of the virtual machine 32. In step S83, the process judges whether the IP address of the transmitter or the receiver of the communication data coincides with a condition set in the communication identifying condition 33. For example, in the first line of the test ACL 12, it is judged on the basis of the IP address whether the transmitter or the receiver is a test client by referring to the test client IP address list 40 shown in FIG. 4.

When it is judged that the communication data coincides the conditions in steps S81 to S83, it is judged in step S66 that the communication data coincides with the conditions concerning the attributes in that line of the test ACL 12. In contrast, when the coincidence judgment fails in any one of steps S81 to S83, it is judged that the communication data does not coincide with the conditions.

When it is judged in step S66 that the communication data does not coincide with the conditions, in step S67, the data controller 11 refers to the next line of the test ACL 12 and, in step S66, judges whether the communication data coincides with conditions concerning attributes in that line. When it is judged in step S66 that the communication data coincides with the conditions, in step S68, rejecting or permitting, which is set as the action 34, is performed. “Rejecting” literally means that no communication data is output by the data controller 11. “Permitting” means that, when the communication data is inward, the communication data is output to an operation or test virtual machine and, when the communication data is outward, the communication data is output from the network device 10 to the external device group 20.

FIG. 7 is a flowchart of a process of judging, by the data controller 11, upon reception of communication data from the operation virtual machine 15 or the test virtual machine 16, an action to be performed on the communication data by referring to the test ACL 12.

In step S701, the data controller 11 receives communication data from a virtual machine.

In step S702, it is judged whether the test ACL 12 is valid. Specifically, the test ACL 12 is valid when a test is to be conducted on the changed settings of the network device 10. In contrast, the test ACL 12 is invalid when no test is to be conducted on the settings; that is, the communication data is in a normal operating state. When it is judged in step S702 that the test ACL 12 is invalid, the process proceeds to step S703.

In step S703, it is judged whether the received communication data is from the test virtual machine 16. When it is judged that the communication data is from the test virtual machine 16, the communication data is rejected since no test is to be performed in this state. Otherwise, the communication data is in a normal operating state and is hence transmitted unchanged to the external device group 20.

In step S706, appropriate flags are added to the received communication data in order to perform judgment using the test ACL 12. When the received communication data is from the operation virtual machine 15, as shown in portions (d) and (e) of FIG. 5, an “operation” flag and an “outward” flag are added to the communication data. When the received communication data is from the test virtual machine 16, as shown in portions (f) and (g) of FIG. 5, a “test” flag and an “outward” flag are added to the communication data.

The processing in steps S707 to S710 is similar to the processing in steps S65 to S68 of FIG. 6.

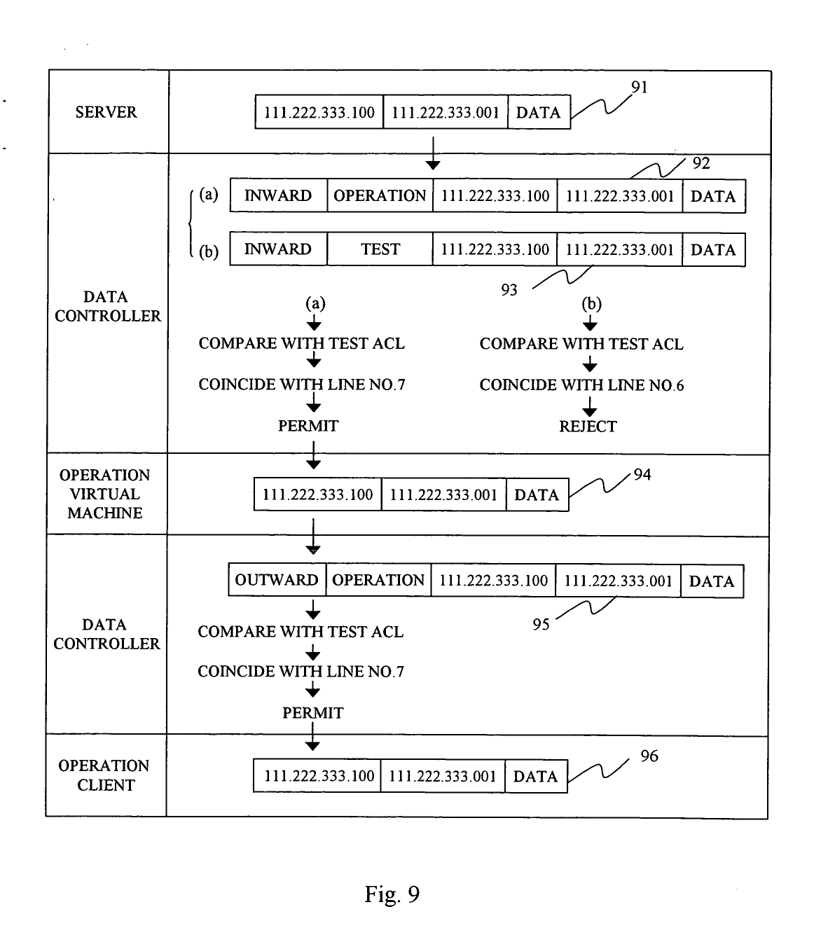

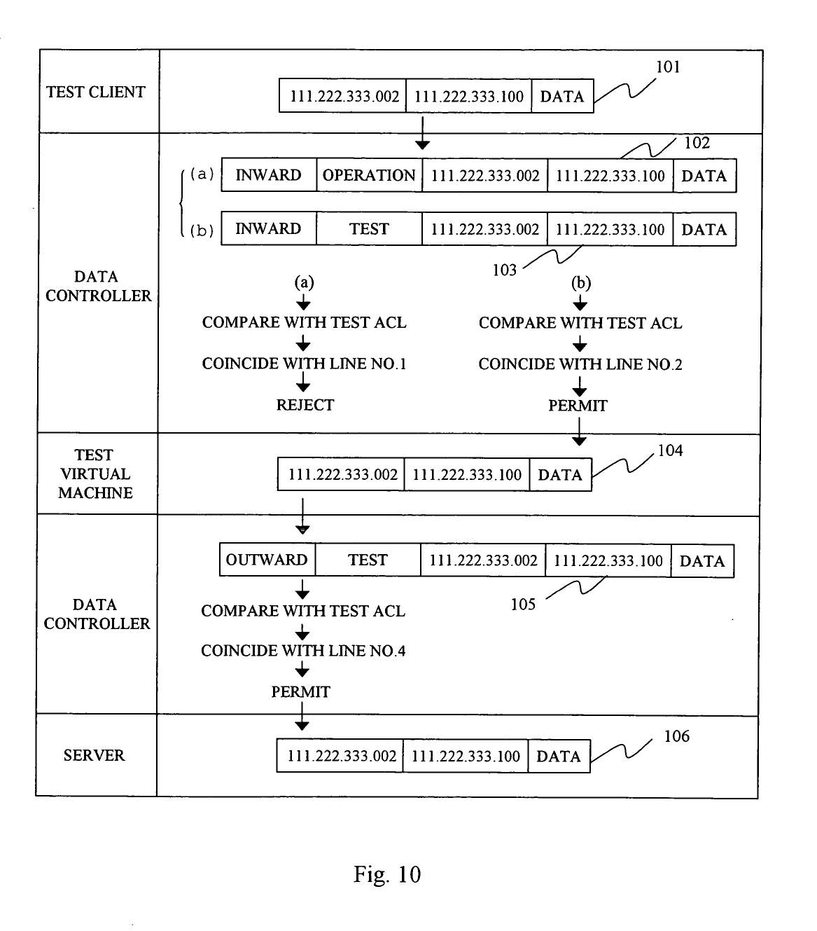

Referring to FIGS. 9 and 10, an example of the specific processing of the present invention will now be described.

FIG. 9 illustrates an example of transmission of data from the server 25 to the operation client 21. This transmission is not for testing, but for normal operation.

Communication data 91 transmitted from the server 25 includes the IP address “111.222.333.100” of the server 25 serving as the transmitter and the IP address “111.222.333.001” of the operation client 21 serving as the receiver. Upon transmission of the communication data 91 to the data controller 11, the communication data 91 is copied to operation-virtual-machine communication data 92 and test-virtual-machine communication data 93. An “operation” flag and a “test” flag are added to the operation-virtual-machine communication data 92 and the test-virtual-machine communication data 93, respectively. In addition, an “inward” flag indicating that the data is from the external device group 20 to a virtual machine is added to the operation-virtual-machine communication data 92 and the test-virtual-machine communication data 93.

In accordance with steps S65 to S67 of FIG. 6 and the flowchart of FIG. 8, the data controller 11 sequentially compares each of the operation-virtual-machine communication data 92 and the test-virtual-machine communication data 93 with conditions set in the test ACL 12, starting from line No. 1. The operation-virtual-machine communication data 92, shown in portion (a) of FIG. 9, indicates that both the transmitter and the receiver are not test clients, and the receiver is not the network device 10. Therefore, the operation-virtual-machine communication data 92 does not coincide with line Nos. 1 to 5 in FIG. 3. Since the operation-virtual-machine communication data 92 includes the “operation” flag indicating that this is for an operation virtual machine, the operation-virtual-machine communication data 92 does not coincide with line No. 6 in FIG. 3. The operation-virtual-machine communication data 92 coincides with line No. 7 in FIG. 3. Accordingly, the operation-virtual-machine communication data 92 is, as set in the action 34 in line No. 7, “permitted” to be communicated, thereby being transmitted to the operation virtual machine 15. The test-virtual-machine communication data 93, shown in portion (b) of FIG. 9, indicates that both the transmitter and the receiver are not test clients, and the receiver is not the network device 10. Therefore, the test-virtual-machine communication data 93 does not coincide with line Nos. 1 to 5. Since the test-virtual-machine communication data 93 includes the “test” flag indicating that this is for a test virtual machine, the test-virtual-machine communication data 93 coincides with line No. 6. Accordingly, the test-virtual-machine communication data 93 is “rejected”, as set in the action 34 in line No. 6.

Communication data 94 transmitted to the operation virtual machine 15 is processed by the operation virtual machine 15 performing a function of the network device 10, and is then transmitted to the data controller 11. The data controller 11 adds, to the communication data 94, an “operation” flag indicating that the communication data 94 is communication data from the operation virtual machine 15 and an “outward” flag indicating that the communication data 94 is communication data from the virtual machine to the external device group 20, thereby generating outward data 95 to be compared with the test ACL 12. This outward data 95 indicates that both the transmitter and the receiver are not test clients, and the receiver is not the network device 10. Therefore, the outward data 95 does not coincide with line Nos. 1 to 5. Since the outward data 95 includes the “operation” flag indicating that this is for an operation virtual machine, the outward data 95 does not coincide with line No. 6. The outward data 95 coincides with line No. 7. Accordingly, the outward data 95 is, as set in the action 34 in line No. 7, “permitted” to be communicated, thereby being transmitted to the operation client 21.

As described above, communication data transmitted from the server 25 to the operation client 21 is appropriately processed by the operation virtual machine 15 in the network device 10. Communication is thus performed similarly to the normal operating state.

FIG. 10 illustrates an example of transmission of data from the test client 22 to the server 25. This transmission is communication for testing the network device 10 by the test client 22.

Communication data 101 transmitted from the test client 22 includes the IP address “111.222.333.002” of the test client 22 serving as the transmitter and the IP address “111.222.333.100” of the server 25 serving as the receiver. Upon transmission of the communication data 101 to the data controller 11, the communication data 101 is copied to operation-virtual-machine communication data 102 and test-virtual-machine communication data 103. An “operation” flag and a “test” flag are added to the operation-virtual-machine communication data 102 and the test-virtual-machine communication data 103, respectively. In addition, an “inward” flag indicating that the data is from the external device group 20 to a virtual machine is added to the operation-virtual-machine communication data 102 and the test-virtual-machine communication data 103.

In accordance with steps S707 to S710 of FIG. 7 and the flowchart of FIG. 8, the data controller 11 sequentially compares each of the operation-virtual-machine communication data 102 and the test-virtual-machine communication data 103 with conditions set in the test ACL 12, starting from line No. 1. Since the operation-virtual-machine communication data 102, shown in portion (a) of FIG. 10, is transmitted from a test client 22 and includes the “operation” flag indicating that this is for an operation virtual machine and the “inward” flag, the operation-virtual-machine communication data 102 coincides with line No. 1. Therefore, the operation-virtual-machine communication data 102 is “rejected”, as set in the action 34 in line No. 1. Since the test-virtual-machine communication data 103, shown in portion (b) of FIG. 10, is transmitted from a test client and includes the “test” flag indicating that this is for a test virtual machine and the “inward” flag, the test-virtual-machine communication data 103 coincides with line No. 2. Therefore, the test-virtual-machine communication data 103 is, as set in the action 34 of line No. 2, “permitted” to be communicated, thereby being transmitted to the test virtual machine 16.

Communication data 104 transmitted to the test virtual machine 16 is processed by the test virtual machine 16 performing a function of the network device 10 relating to the changed settings, and is then transmitted to the data controller 11. The data controller 11 adds, to the communication data 104, a “test” flag indicating that the communication data 104 is communication data from the test virtual machine 16 and an “outward” flag indicating that the communication data 104 is communication data from the virtual machine to the external device group 20, thereby generating outward data 105 to be compared with the test ACL 12. Since this outward data 105 is transmitted from a test client and includes the “test” flag indicating that the data is for a test virtual machine, the outward data 105 does not coincide with line Nos. 1 to 3. The outward data 105 coincides with line No. 4. Accordingly, the outward data 105 is, as set in the action 34 in line No. 4, “permitted” to be communicated, thereby being transmitted to the server 25.

As described above, communication data transmitted from the test client 22 to the server 25 is appropriately processed by the test virtual machine 16 with the changed settings in the network device 10. Communication for testing the changed settings is thus performed without interrupting normal operation.

In the foregoing embodiment and operation thereof of the present invention, the test ACL 12 is a table defining conditions concerning “inward” communication data transmitted from an external device and conditions concerning “outward” communication data transmitted from a virtual machine. All pieces of communication data are tested by referring to this single test ACL 12. However, the present invention is not limited to such a structure.

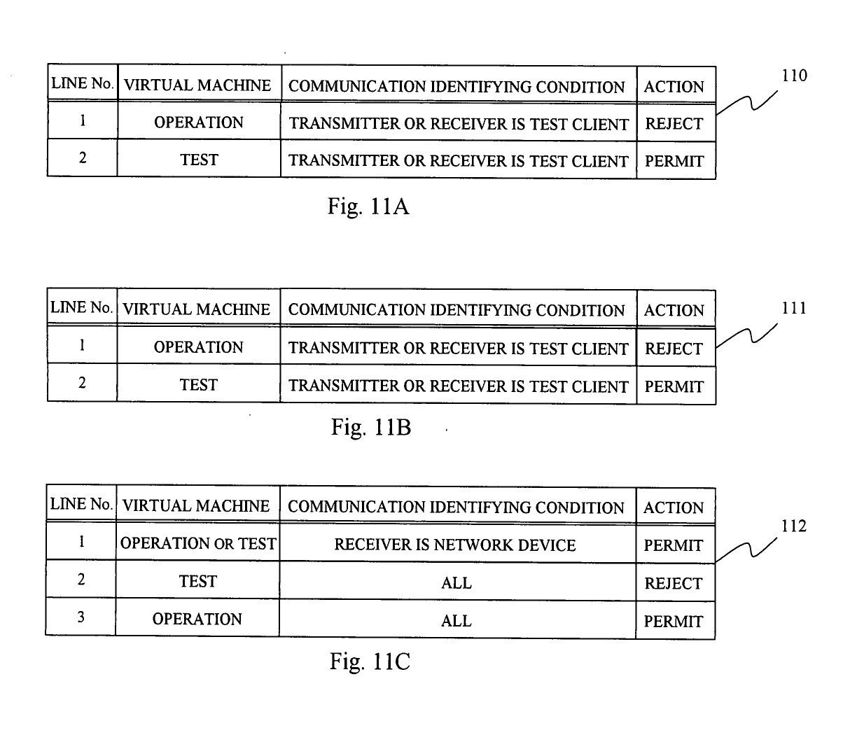

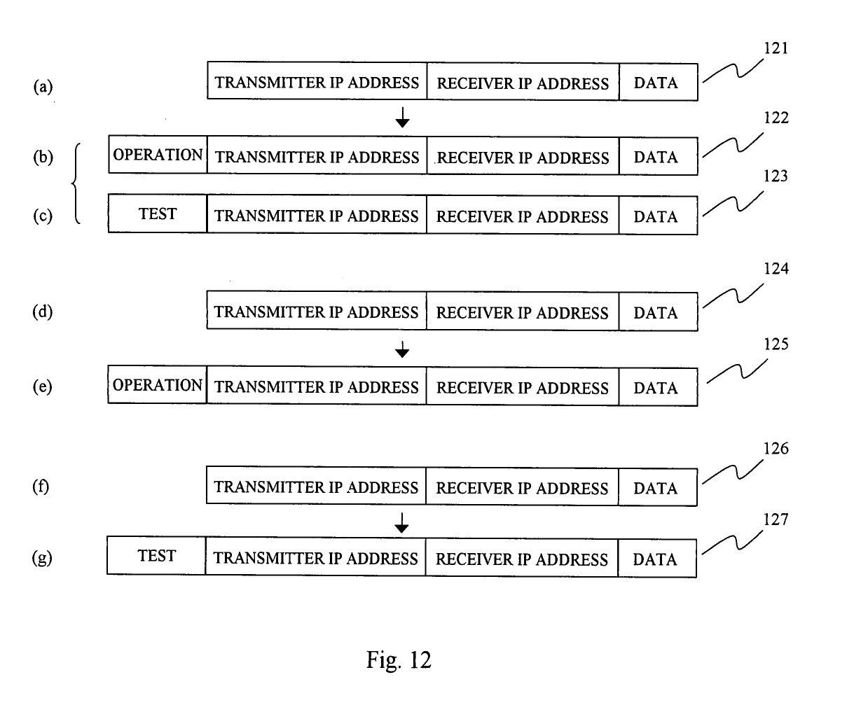

FIGS. 11A to 11C show examples in which communication data from an external device to a virtual machine is handled separately from communication data from a virtual machine to an external device, and test ACLs for the two types of communication data are separately provided. Referring to FIG. 12, inward communication data 121 from an external device to a virtual machine is copied by the data controller 11 to operation-virtual-machine communication data 122 provided with an “operation” flag and test-virtual-machine communication data 123 provided with a “test” flag. Each of the operation-virtual-machine communication data 122 and the test-virtual-machine communication data 123 is compared with a test ACL 110 from an external device to a virtual machine. When the communication data coincides with conditions, permitting or rejecting, which is set as an action, is performed. In contrast, when the communication data does not coincide with the conditions, reference is made to a test ACL 112 of bidirectional communication data, a process set as the action in a line in which the communication data coincides with the conditions is performed. The data controller 11 adds an “operation” flag to communication data 124 from an operation virtual machine to an external device, thereby generating communication data 125 for the external device. The communication data 125 is compared with conditions in each line of a test ACL 111 associated with communication data from a virtual machine to an external device and, when the communication data 125 coincides with the conditions, a process set as the action in that line is performed. When the communication data 125 does not coincide with the conditions, reference is made to the test ACL 112 of bidirectional communication data, and a process set as the action in a line in which the communication data coincides with the conditions is performed. The data controller 11 adds a “test” flag to communication data 126 from a test virtual machine to an external device, thereby generating communication data 127 for the external device. The communication data 127 is compared with conditions in each line of the test ACL 111 associated with communication data from a virtual machine to an external device, and, when the communication data 127 coincides with the conditions, a process set as the action is performed. When the communication data 127 does not coincide with the conditions, reference is made to the test ACL 112 of bidirectional communication data, and a process set as the action in a line in which the communication data coincides with the conditions is performed.

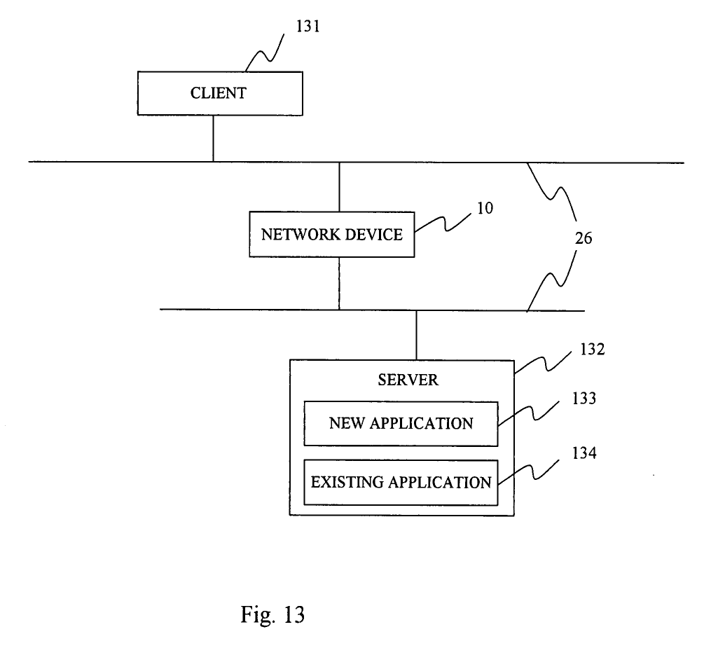

Although a case in which the IP address of each client is set as the communication identifying condition has been described in the first embodiment, another condition may be set as the communication identifying condition. A second embodiment in such a case will now be described with reference to FIGS. 13 to 15.

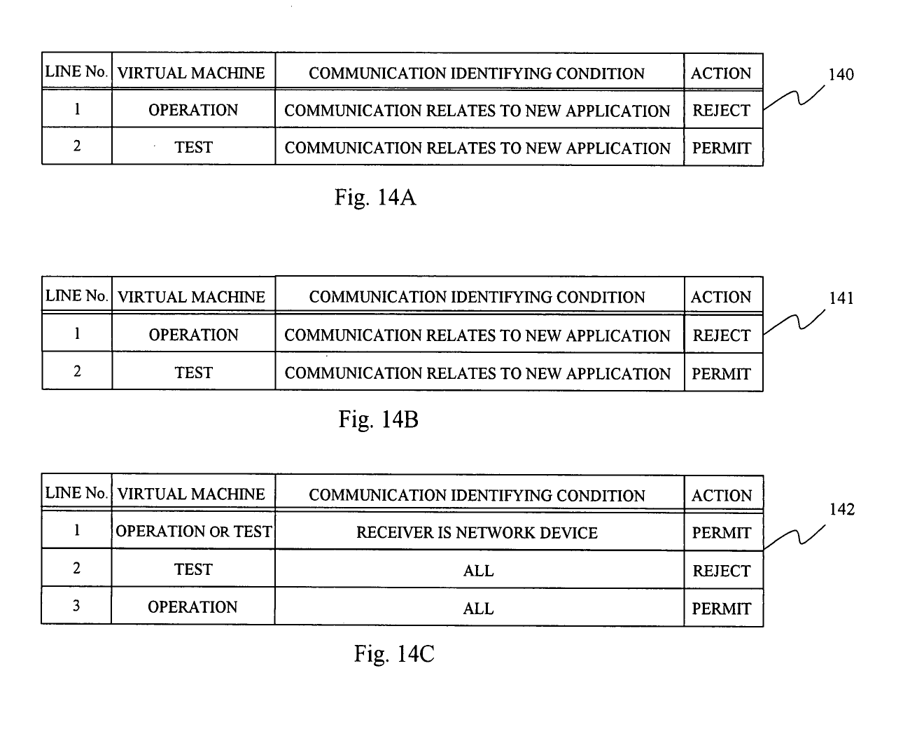

FIG. 13 shows the structure of the second embodiment. A client 131 and a server 132 are interconnected via the network 26 and the network device 10. The server 132 includes an existing application 134, which is running, and a new application 133, which is to be added and tested to see whether it will operate properly. It is an object of the second embodiment to test the operation of the network device 10 for launching the new application 133 and the operation of the entire network system without having an effect on the running state of the existing application 134. FIGS. 14A to 14C show test ACLs of the second embodiment, which are similar in structure to those shown in FIGS. 11A to 11C. These test ACLs of the second embodiment (shown in FIGS. 14A to 14C) differ from those shown in FIGS. 11A to 11C in that the test ACLs of the second embodiment have different items set in the communication identifying condition. Judgment is performed on the basis of a condition, whether communication data relates to the new application 133, which is set in each line of each of the test ACLs. There are several possible methods for distinguishing communication data associated with the new application 133. For example, when the existing application 134 and the new application 133 are installed separately in different servers, unlike the server 132 shown in FIG. 13 including both the existing application 134 and the new application 133, the communication identifying condition may include the IP address of the server including the new application 133. In a case of the structure shown in FIG. 13 in which the existing application 134 and the new application 133 are distinguished from each other by a transmission control protocol (TCP) service port of the server 132, as shown in FIG. 4, the TCP service port may be set as the communication identifying condition of each of the test ACLs 140, 141, and 142. Judgment is thus performed on the basis of the TCP service port included in the communication data.

Although not shown in the drawing, the network device 10 is one type of computer whose overall operation is controlled by a CPU. A random access memory (RAM), a hard disk drive (HDD), an input/output interface, a communication interface, and the like are connected to the CPU via a bus.

The RAM temporarily stores an operating system (OS) program and at least part of other programs to be executed by the CPU. The RAM also stores various necessary data for the processing by the CPU. The HDD stores the OS, other programs, and data.

The processes described in the flowcharts of FIGS. 6 to 8 according to the first embodiment of the present invention may be provided as programs. By executing these programs on the computer, the computer functions as the network device 10.

Processes of functions that should be included in the above computer may be written in a program recorded on a computer-readable recording medium. By executing this program on the computer, the foregoing processes may be performed by the computer. The computer-readable recording medium includes a magnetic recording device or a semiconductor memory. To distribute such a program in the market, the program is stored on a portable recording medium, such as a compact disk read only memory (CD-ROM) or a flexible disk, and is distributed. Alternatively, the program may be stored in a memory of a computer connected via a network, and the program may be transferred via the network to another computer. To execute the program on the computer, the program is stored in a hard disk drive in the computer, and the program is loaded into a main memory and is executed.

What is claimed is:

1. A method for testing a network system by controlling, by a data controller in a network device, communication data transferred between an external device connected to the network device via a network and a plurality of virtual machines in the network device, comprising:
a reception step of receiving the communication data;
a judgment step of judging whether the received communication data coincides with the condition by referring to a test access control list whitch defines association between a condition cocerning an attribute of the communication data and an action serving as a process of permitting or rejecting communication of the communication data; and
an execution step of executing, when it is judged in the judgment step that the communication data coincides with the condition, the process serving as the action in the test access control list.

2. A method for testing a network system according to claim 1, wherein the condition concerning the attribute of the communication data includes address information for identifying the location on the network of the external device or the network device serving as a transmitter or a receiver of the communication data, and
the judgment step includes judgment of whether address information included in the received communication data coincides with the condition concerning the attribute of the communication data.

3. A method for testing a network system according to claim 1, further comprising an addition step of adding, to the received communication data, a necessary attribute for judging whether the communication data coincides with the condition in the judgment step.

4. A computer-readable medium encoded with a network-system testing program for causing a computer to operate as a network device controlling communication data transferred between external devices interconnected via a network, the program causing the computer to perform a process comprising:
a reception step of receiving communication data transmitted from one of the external devices or communication data transmitted from a virtual machine in the network device;
a judgment step of judging whether the received communication data coincides with the condition by referring to a test access control list whitch defines association between a condition cocerning an attribute of the communication data and an action serving as a process of permitting or rejecting communication of the communication data; and
an execution step of executing, when it is judged in the judgment step that the communication data coincides with the condition, the process serving as the action in the test access control list.

5. A computer-readable medium encoded with a network-system testing program according to claim 4, wherein the condition concerning the attribute of the communication data includes address information for identifying the location on the network of the external device or the network device serving as a transmitter or a receiver of the communication data, and
wherein the judgment step includes judgment of whether address information included in the received communication data coincides with the condition of the attribute of the communication data.

6. A computer-readable medium encoded with a network-system testing program according to claim 4, the program further comprising:
an attribute adding step of adding, to the received communication data, a necessary attribute for judging whether the communication data coincides with the condition in the judgment step.

7. A network-system testing apparatus for controlling communication data transferred between external devices interconnected via a network, comprising:
reception means for receiving communication data transmitted from one of the external devices or communication data transmitted from a virtual machine in the network device;
a test access control list whitch defines association between a condition cocerning an attribute of the communication data and an action serving as a process of permitting or rejecting communication of the communication data when the communication data coincides with the condition;
judgment means for judging, by referring to the test access control list, whether the received communication data coincides with the condition; and
execution means for executing the action in the test access control list when it is judged by the judgment means that the communication data coincides with the condition.

8. A network-system testing apparatus according to claim 7, wherein the condition concerning the attribute(s) of the communication data includes address information for identifying the location on the network of the external device or the network device serving as a transmitter or a receiver of the communication data, and
the judgment means judges whether address information included in the received communication data coincides with the condition concerning the attribute(s) of the communication data.

9. A network-system testing apparatus according to claim 7, further comprising attribute adding means for adding, to the received communication data, a necessary attribute for judging, by the judgment means, whether the communication data coincides with the condition.
